(19) United States
(12) Patent Application Publication
(10) Pub. No.: US 2002/0007361 A1
(43) Pub. Date: Jan. 17, 2002

(54) Management of products and parts

(76) Inventors: Kazuhiro Esaki, Kanagawa (JP); Kiyoshi Kobayashi, Kanagawa (JP); Toyomi Nishi, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 09/903,583

(22) Filed: Jul. 13, 2001

(30) Foreign Application Priority Data
Jul. 14, 2000 (JP) 213763/2000

(51) Int. Cl. G06F 17/30

(52) U.S. Cl. 707/4

(57) ABSTRACT

A method of managing of products each having a plurality of parts is provided. In the method, at first, an original structural tree of a product which defines a relationship between the product and its parts is created and then part numbers are assigned to the product and parts. Products and parts having the same structure are allocated with the same part number. Next unique serial numbers are assigned to the product and at least major parts thereof. Different serial numbers are assigned to separate products and parts even if they have the same structure. Then part numbers and serial numbers are entered in the structural tree and the resultant structural tree is stored in a database connected to a computer. The serial numbers are marked on the product and parts assigned therewith, and information of the tree is retrieved by using the serial numbers on the product and parts.

### BACKGROUND OF THE INVENTION

The present invention pertains to management of products and parts, and specifically to a method and system for managing assemblies (assembled products) and their parts Conventionally, an assembled product (or assembly) containing a plurality of parts has been represented by a tree chart such as is shown in FIG. 1 in order to clarify a structure of the product. A tree chart generally shows the relationship between an assembled product and its parts, and the parts are sometimes referred to as sub-assemblies which are still further classified or broken down into smaller parts. By referring to such a tree chart, the detailed structure or design of an assembled product can be recognized.

Although a conventional tree chart as described above helps to clearly show the detailed structure of a product, sometimes there are a large number of products having the same structure and thus are representable by the same tree chart. In such a circumstance, the products that were supplied to different customers cannot be distinguished from one another by using their tree charts. Even if the products are supplied to the same customer, they cannot be distinguished from one another by using their tree charts. Therefore, even though a history of troubleshooting procedure or the like of each of the products is recorded in a document made by the product's designer, customer service workers cannot readily access to those records.

### SUMMARY OF THE INVENTION

Given the aforementioned problems in the prior art. it is an object of the present invention to provide a product/parts management technique in which individual products can be distinguished from one another even if they have the same structure and product information unique to each individual product can be readily retrieved.

In order to achieve the object, the present invention provides a method of managing products and their parts, comprising the steps of:

creating an original structural tree of a product which defines a relationship between the product and its parts:

assigning part numbers to the product and the parts, the same part number being assigned to products and parts having the same structure;

assigning unique serial numbers to the product and at least major parts thereof, different serial numbers being assigned to separate products or parts even if they have the same structure;

entering the part numbers and serial numbers in the structural tree;

storing the resultant structural tree in a database connected to a computer; and

marking the serial numbers on the product and parts assigned therewith.

It is preferable for the method above to further comprise the steps of linking attributes of the product and parts to which the serial numbers are assigned, to the same serial numbers, and storing the attributes together with their linking information in the database. Preferably, the method further comprises the steps of linking histories of the product and parts to which the serial numbers are assigned, to the same serial numbers, and storing the histories together with their linking information in the database.

The present invention also provides a product/parts management server connected to a database and user terminals, for managing products and their parts. comprising:

means for supporting a user to create a structural tree of a product to be stored in the database, which defines the relationship between the product and its parts, and contains part number assigned to the product and the parts and unique serial numbers assigned to the product and at least major parts, the same part number being assigned to products and parts having the same structure, but different serial numbers being assigned to products and parts even having the same structure; and

means for providing information from the structural tree stored in the database to a user terminal when it is retrieved by using the serial numbers.

The present invention further provides a structural tree of a product each having a plurality of parts, for managing the product and parts, wherein the structural tree is made by the steps of:

creating an original structural tree of a product which defines a relationship between the product and its parts;

assigning part numbers to the product and parts, the same part number being assigned to products and parts having the same structure;

assigning unique serial numbers to the product and at least major parts thereof, different serial numbers being assigned to separate products and parts even if they have the same structure;

entering the part numbers and serial numbers in the structural tree; and

storing the resultant structural tree in a database connected to a computer.

### BRIEF DESCRIPTION OF THE DRAWINGS

FIG. 1 shows a tree which is used to represent a structure of an assembled product, according to the prior art;

FIGS. 2(a) and 2(b) show examples of a tree which is used to represent a structure of an assembled product, according to the present invention;

FIG. 3 is a diagram showing a data structure of a tree contained in a parts management server according to the present invention;

FIG. 4 is a diagram showing drawing management data structures stored in files of the parts management server according to the present invention;

FIG. 5 is a diagram showing parts information data structures stored in files of the parts management server according to the present invention;

FIG. 6 is a diagram showing a serial number log data structure stored in a file of the parts management server according to the present invention;

FIG. 7 illustrates flows of procedures executed in a product structure management system where the parts management method utilizing part numbers and serial numbers can be used, according to the present invention;

FIG. 8 is a flowchart showing a procedure for assigning the serial numbers according to the present invention;

FIG. 9 is a flowchart showing a service procedure executed by using the serial numbers according to the present invention; and

FIG. 10 is a conceptual diagram of a computer system suitable for implementing the parts management method according to the present invention.

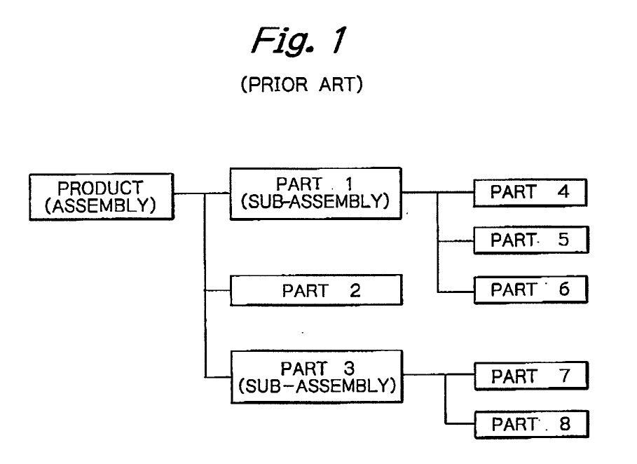

### DETAILED DESCRIPTION OF THE INVENTION

Hereinafter, an embodiment of the present invention will be explained with reference to the drawings. The same or similar components are denoted by the same reference numerals or symbols in the drawings.

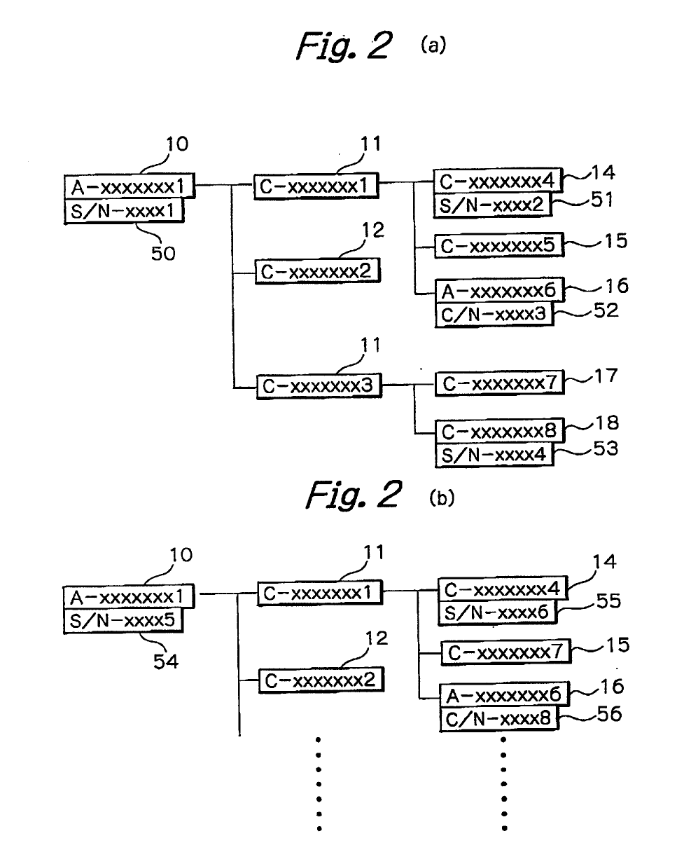

FIGS. 2(a) and 2(b) are explanatory diagrams showing examples of structural trees of assemblies or assembled products having the same structure, according to the present invention. As is illustrated in FIG. 2(a), an assembled product denoted by a part number (P/N) 10 (hereinafter referred to as “product 10”) consists of parts denoted by part numbers 11, 12 and 13 (hereinafter referred to as “parts 11, 12 and 13”. It should be noted that a product can be also conceptually regarded as a part and hence the term “part number” instead of the term “product number” is used in the description. The part 11 consists of parts 14-16 and the part 13 consists of parts 17 and 18 in the product shown in FIG. 2(a). Therefore, each of the parts 11 and 13 is referred to a sub-assembly because they contain a plurality of parts, while each of the parts 12 and 14-18 is merely referred to a part in the structural tree in FIG. 2(a). Parts and sub-assemblies having different structures are respectively identified by individual part numbers, while assemblies or parts having the same constitution are assigned to the same part number.

The tree shown in FIG. 2(b) represents another product having the same structure as that shown in FIG. 2(a) though the parts 13, 17 and 18 are omitted in FIG. 2(b). As can be seen from the trees illustrated in FIGS. 2(a) and 2(b), when two or more separate products are of the same design or structure, their tree structures are exactly the same because parts of the same design are provided with the same part number in prior arts. Thus, products having the same design or structure can be defined univocally by the same tree.

In the trees shown in FIGS. 2(a) and 2(b), the product 10 and the parts 14, 16 and 18 are selected as major parts, to which serial numbers are assigned. The serial numbers allocated to the major parts including the product itself are denoted by the reference numerals 50, 51, 52 and 53 respectively in FIG. 2(a), and the reference numerals 54, 55, and 56 respectively in FIG. 2(b).

The serial numbers do not have to be numbers in sequence. However, the same serial number is not assigned to two separate parts even though they are of the same structure. Therefore, by designating a specific serial number, a particular separate part can be identified and thus information of the part such as a vendor and/or buyer of the part, a product including the part, etc. can be also identified. The serial numbers 50 and 54 for the respective products 10 may be product numbers which are set by someone who takes an order and instructs a designer to make a design of the product. When a plurality of products of the same design are ordered and manufactured, the products are provided with different serial numbers. Namely, it is essential that physically separate products and parts are provided with different serial numbers even though they are of the same design.

Although serial numbers are assigned only to major parts including a product in this embodiment, they may be assigned to any parts. Although they may be assigned to sub-assemblies, it is preferable to allocate serial numbers only to a product and final unit parts which cannot be divided into lower parts. As is previously described, a product (manufacturing) number may be utilized as a serial number of a product.

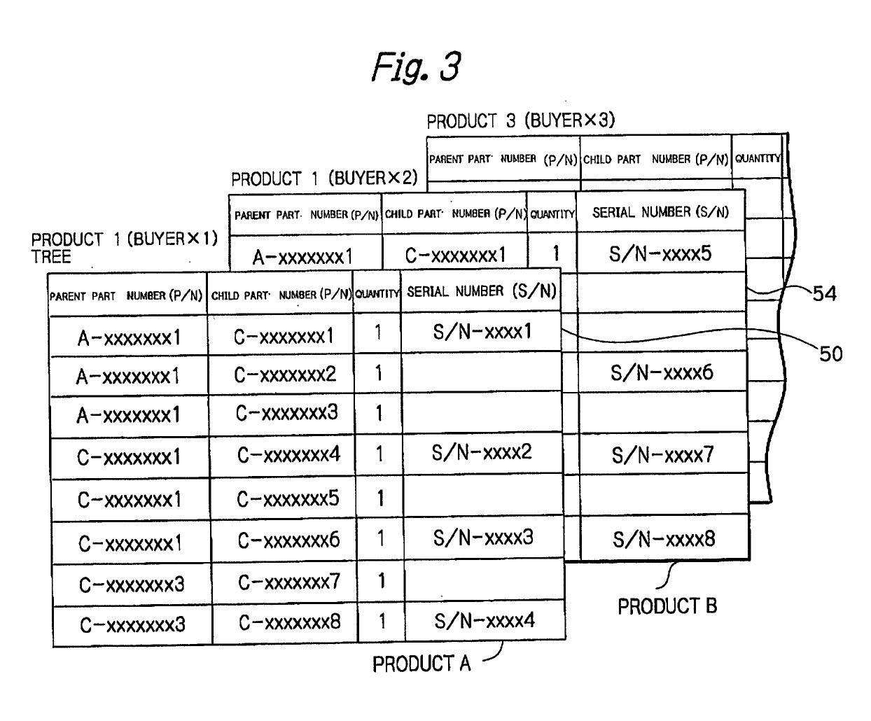

With reference to FIG. 3, data structures of trees according to the present invention will be explained. The data structures are formed as tree data tables incorporated in a parts management server (or a computer). From left to right in FIG. 3 showing an example of the tree data table, the first through fourth columns in each of the tables represent a parent part number, a child part number, a quantity, and a serial number.

The first (or top) and second tree data tables in FIG. 3 respectively show data structures of the trees associated with the products 10 illustrated in FIGS. 2(a) and 2(b), which are assigned the serial numbers “S/N-xxxxxxx1 (50) and “S/N-xxxxxxx5 (54). By the same token, trees of individual products to which different serial numbers are assigned are respectively formed in tables. Such tree data tables are stored as files in the parts management server.

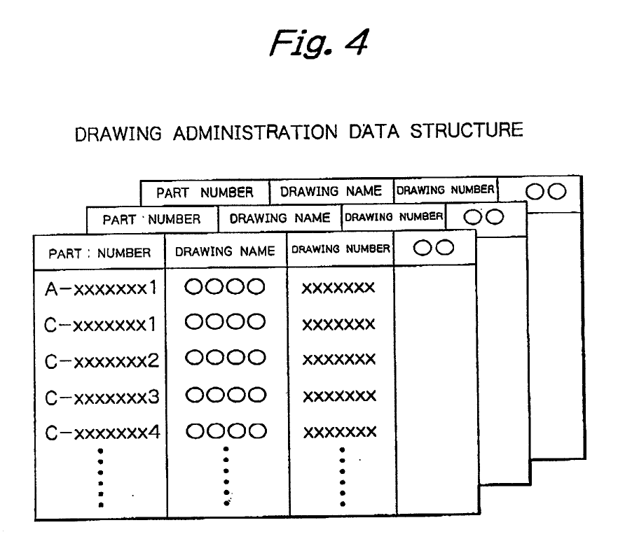

FIG. 4 illustrates tables of drawing administration data structures stored as files in the parts management server. In each of the tables in FIG. 4, the first through third columns represent a part number, a drawing name, and a drawing number. Further columns such as fourth, fifth columns may be added to store other information such as the date of issuance of a drawing, the name of a person who made the drawing, the history of the drawing, etc. One drawing management table is prepared for products having the same design. As was explained with reference to the tree data tables in FIG. 3, a serial number is linked to a part number. Therefore, by identifying a serial number, a drawing number and other data about a part to which the serial number is assigned can be obtained from the tables in FIGS. 3 and 4. Conversely, by identifying a part number, serial numbers of parts manufactured in accordance with specific drawings can be enumerated, whereby buyers, vendors, etc. of the parts can be identified.

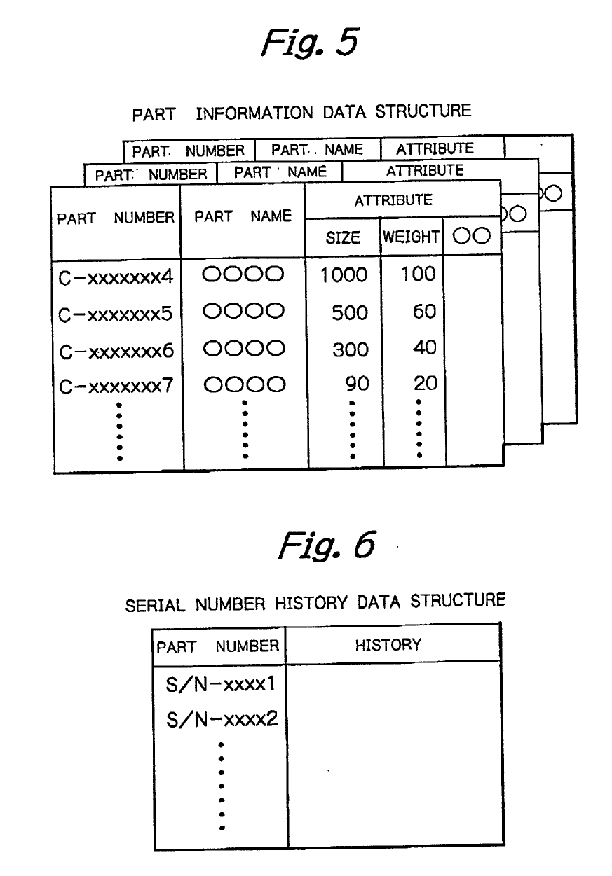

FIG. 5 shows tables for parts information data structures stored as files in the parts management server. In each of the tables in FIG. 5, the first through third columns respectively represent a part number, a parts name and attributes. The column representing the attributes is further classified into columns for a size, weight, etc.

FIG. 6 shows a table for a serial number history data structure in which the first and second columns represent a serial number and history. This table is also stored as a file in the parts management server. From the table in FIG. 6, a history of each part identified by a serial number can be found, which includes remodeling on site (remodeling conducted via a design section), etc. A history in the table may be in the form of document data or image data (photographs, illustration, etc.). Alternatively, a history may be stored as an attachment file which is linked to the corresponding serial number.

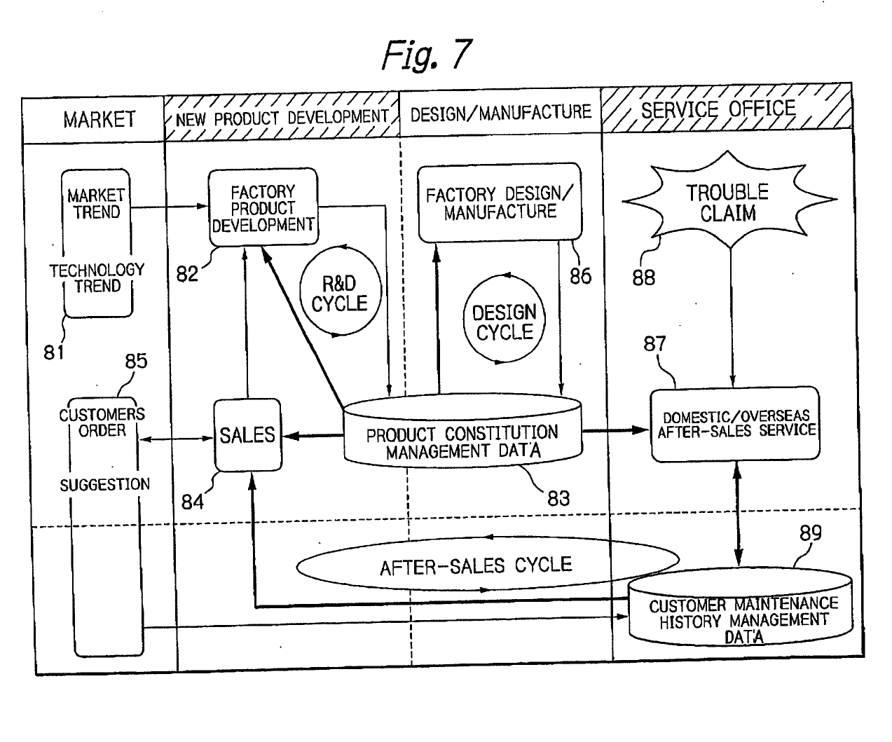

With reference to a flowchart illustrated in FIG. 7, a product structure management system will be explained, in which a parts management method employing the above-described part numbers and serial numbers can be implemented. The system concerns a market, new product development, design/manufacture and service systems. It is to say that the product structure management system has a circulative business model incorporated.

The model principally consists of three operation cycles. The first operation cycle is a “research and development cycle” for a new product. During the first cycle, known design information verified and accumulated in a product structure management database is referred to and used as much as possible in the process of research and development of a new product, whereby a new product development efficiency is improved and consistent quality is maintained. Further, established common product information is packaged as a unit in the process of development and the packaged information is registered in the product structure management database and published as standard product information.

The second cycle is a “design cycle” for customized products for specific customers. During the second cycle, standard technique/design information of similar verified products accumulated in the product structure management database is fully referred to and used, in accordance with specifications of products ordered. Therefore, a time period for facilitating design of a customized product may be shortened, and cost may be reduced, while maintaining product quality. At this stage, it is important to design portions added/changed in accordance with needs unique to a specific customer.

The third cycle is an “after-sales cycle”. During the third cycle, post maintenance information about trouble and claims concerning supplied products, preventive maintenance information gathered by periodic inspections and predictive maintenance information gathered from product's remote monitors and projection data are utilized, together with information registered in the product structure management database. Using such information, “after-sales-service” is supported in a timely manner. Further, by feeding such information back to sales sections, sales activities as well as quality assurance may be facilitated.

According to the present system shown in FIG. 7, the following measures are implemented.

(a) Identification of Product Type (Systematic Assignment of Product Type Code (or Part Number (P/N))

In order to register/accumulate/share design/technology information about various lines of products to be developed in the future, and retrieve and identify such product information when the information is necessary for manufacturing, after-sales-service, etc., systematic assignment of part numbers (P/N) is effective because the part numbers enable ready identification of types of products.

When product information is systematically classified using P/Ns, product types can be more easily identified even by rather primitive means (e.g., means employing a 12 digit code) than IT retrieval means. Further, it is easy to commonly utilize compatible parts and products. Still further, by utilizing IT retrieval techniques in which keys are allocated to attributes, products can be identified and retrieved more easily.

(b) Identification of Product (Assignment of Product Specific Code (or Serial Number (S/N))

Products of great importance in terms of after-sales-service are associated with design information and allocated serial numbers (SIN) as explained above. Management by means of S/N makes it possible to identify not only a type of a product but also a separate individual product itself.

(c) Centralized Control of Product Technology/Design Information (Intensive Management of Product Design/Technical Information of Electronic Data)

It is possible to centralize various kinds of meta-data about standard products and products for a specific customers and bulk data associated with product composition. The meta-data contains parent-child relation information about products and parts, and various information about of attributes, purchase and manufacturing costs, and remodeling histories, for instance. The bulk data contains drawings, documents, specifications, design change information, business showings, table of parts, and so on.

By retrieving and referring to this technical information at the time of designing a similar product intended for a specific customer, it is possible to convey from a design section to a manufacturing section, only the differences between the structure trees of the product to be manufactured and the reference (or standard) product. Therefore, a drawing transfer working operation can be substantially simplified and facilitated. Further, necessary product information can be provided on web pages through a PDM system (Product Data Management System) at a factory, whereby even overseas after-sales-service offices can access and refer to the information.

(d) Simplification of Operation Procedure (Standardization of Business Process by Means of Process Management Function and Implementation of Various Retrieval Means)

By managing a design operation flow of “design”—“drawing inspection”—“approval”—“registration”—“distribution” in an automatic and paperless fashion, the efficiency of operations can be substantially improved. Further, functions of retrieval based on various keys of product information accumulated in a database, conditions and attribute information, etc. and reverse retrieval, difference retrieval, roots retrieval, copy, use retrieval, etc. can be implemented. Using such functions, after-sales-service can be improved. For example, using the reverse retrieval function, customers who bought faulty products or parts can be easily identified.

In FIG. 7, market trend/technology trend information 81 is inputted to a product development section 82 in a factory mainly via a sales section. Based on such trend information, the section 82 may develop products. Information about the resultant products are stored as product structure management data 83 in files of a server computer. The database 83 can be accessed from a sales section 84. The sales section 84 is directly associated with customers 85 so as to accept orders, suggestions, etc. therefrom and reply to customer's inquiries by referring to the database 83.

The database 83 can be accessed by the product development section 82 in the factory to obtain the information therein. This section 82 acts or works in the research and development cycle.

The database 83 can be also accessed by a design/manufacture section 86 in a factory to obtain the information thereof. In the section 86, products and parts are designed and manufactured in accordance with the information in the database 83. The section 86 works in design cycle.

The database 83 can be also accessed by a domestic and overseas after sales service station 87 to obtain the information therein. In accordance with the information obtained from the database 83, after-sales service is provided. When a supplied product fails or a claim is put in (88), a request for dealing with the failure or claim may be made to the after-sales service station 87. Upon receiving the request, the after-sales service station 87 accesses the product management database 83 and after-sales service such as repair or replacement is provided based on the information in the database 83. The result of the service is stored in a customer maintenance history management data file 89.

The product structure management data file 83 and the customer maintenance history management data file 89 are indicated as two separate files in FIG. 7. However, they may constitute a single file and design data and the corresponding maintenance history management data are linked with the same serial number and stored in the file together.

The customer maintenance history management data file 89 can be accessed by the sales section 84. In the section 84, sales activities can be conducted by referring to the information of the database 89. Further, the section 84 can input and store information into the product structure management database 82. This section works in the after-sales service business cycle.

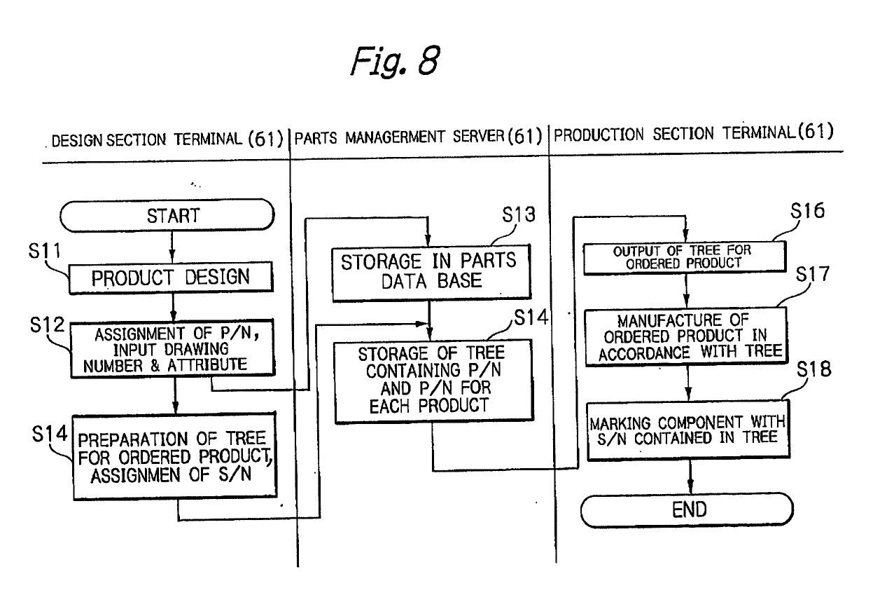

With reference to FIG. 8, a procedure for assigning serial numbers (S/Ns) will be explained below. First, the design section designs a product in response to an order report from the sales section (S11). During the design procedure or upon its completion, a part number P/N is assigned to each part. Each part number P/N is linked to a drawing number, and if necessary, attributes are associated with the P/N. Subsequently, the part numbers PINs, drawing numbers and attributes are inputted through a design terminal, for example, personal computer 61 (see FIG. 8) on the desk of each designer and transmitted to a parts management server 62 (S12).

The parts management server 62 stores in the parts database file the inputted part numbers, drawing numbers and attributes of the parts (S13).

The designer prepares a structural tree for an ordered product and assigns serial numbers (SINs) to major parts of the product, that is, parts to be managed for the future after-sales service, etc. and inputs the assigned serial numbers through the design terminal. The parts management server 62 stores in a tree database file the tree containing the inputted part numbers and serial numbers for each product (S15).

A production section terminal 63 obtains from the parts management server 62, the tree corresponding to the ordered product (S16). With reference to the outputted tree, the production section manufactures a product whose buyer has already been determined (S17). The production section marks major parts with serial numbers contained in the tree (S18). The serial numbers may be inscribed or written in paint on the part, or a sticker carrying a serial number may be affixed to the part.

Further, a part may be marked with a serial number on the associated product when it is completed or immediately before the assembled product containing the part is shipped. If a part is marked with a serial number when it is completed, it has to be verified that the part identified by the serial number is built into the product in which the part was intended to be incorporated at the design stage. Irrespective of timing of marking of serial numbers, different serial numbers have to be assigned to different parts (even though the parts are of the same design).

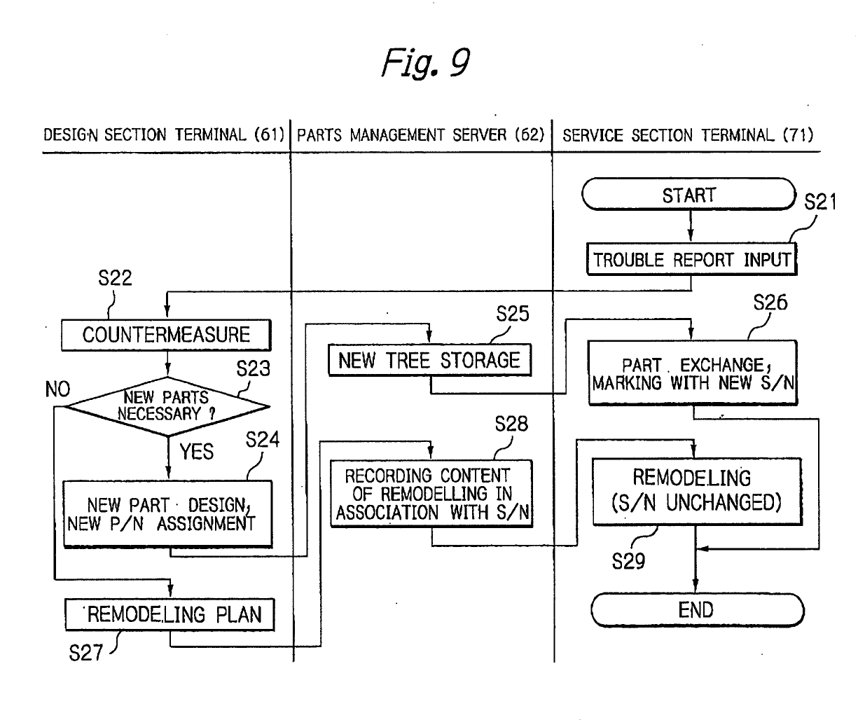

Next, with reference to FIG. 9, a procedure of service provided by utilizing serial numbers will be explained. When a problem occurs, a service person is dispatched to the site to study the problem and reports the result of the study back to the design section (Step S21). Although the report of the result of the study may be directed to the quality control section instead of the design section, it eventually has to be forwarded to the design section if the design section needs to be involved to solve the problem.

Upon receiving the report, a designer comes up with countermeasure (Step 22). Based on the proposed countermeasure, it is determined whether it is necessary to design new parts (Step 23). If so, a designer designs the new ones and assigns new part numbers, serial numbers and, if necessary, drawing numbers to the newly designed parts, and inputs the assigned numbers through the design terminal 61 (Step 24).

The parts management server 62 stores in the tree structure database file the new tree containing the inputted new part numbers and serial numbers (Step 25). The new drawing numbers are stored in the drawing administration database file. The drawing numbers and the part numbers are linked.

Although serial numbers are assigned at the design section in the above embodiment, it may be arranged such that serial numbers which have not been assigned yet are assigned automatically in a computer.

At the service section, the service terminal 71 accesses the parts management server 62 and outputs new serial numbers and marks the new parts with the new serial numbers (Step 26).

On the other hand, when it is decided at Step 23 that new parts are not necessary, a designer comes up with a remodeling plan. Remodeling means chipping a portion of a component, making a hole in a component, etc. and does not include exchange of component parts per se. If the parts are changed for new parts of the same design, new serial numbers are assigned to the new parts. Thus, even though a tree containing part numbers only does not change, a new tree containing the new serial numbers replaces the old one. The remodeling information is transmitted to the parts management server 62 and recorded in the server 62 wherein the remodeled parts and their serial numbers agree. Thus, a history of each part is recorded in the file of the parts management server 62.

The service section conducts remodeling in response to an instruction from the design section. Since the parts are not exchanged for new parts and but only subjected to processing, their serial numbers are not changed (Step 29).

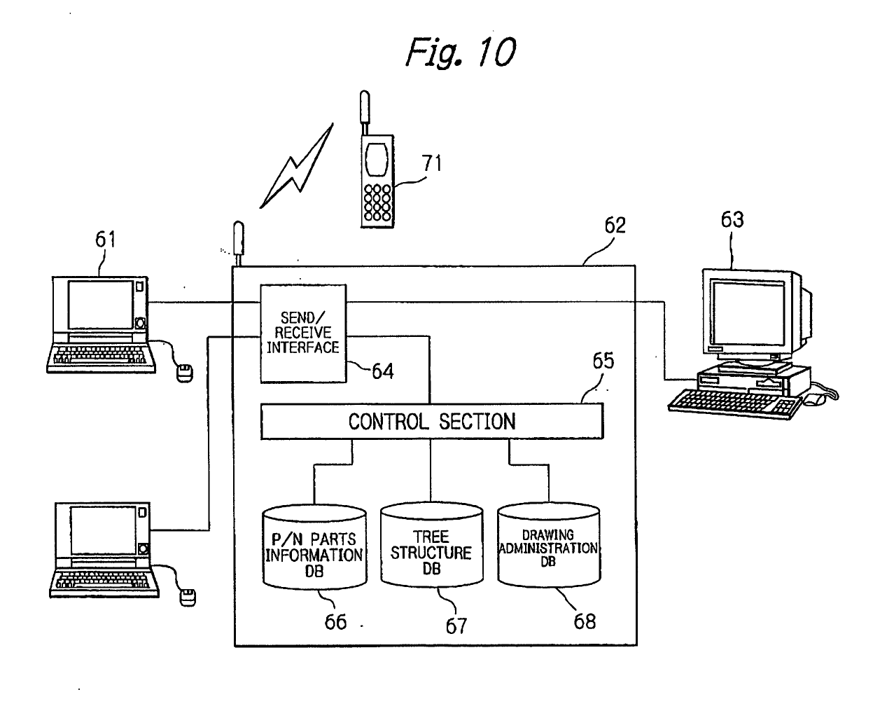

With reference to FIG. 10, a computer system suitable for carrying on a parts management method in accordance with the present invention will be explained. The design terminal 61 is located on a designer desk and is connected to the parts management server 62 via a private line or the Internet. The parts management server 62 may be an office computer of the headquarters or a large capacity personal computer provided at the design section. When the parts management server 62 is a computer at the design section, the design terminal 61 may be only a keyboard, mouse and touch panel connected to the computer.

The parts management server 62 is connected a production section terminal 63 via a private line or the Internet. The production section terminal is, for example, a personal computer provided with an output unit (not indicated in the drawing), for example, a printer for outputting a material table (or tree), a plotter for outputting a drawing, a device for outputting a serial number sticker, etc.

The parts management server 62 is connected further to the service section terminal 71 via a private line or the Internet. Although the service section terminal 71 may be a personal computer, an Internet connectable mobile phone is preferred for its portability and mobility.

As is explained above, according to the present invention, design information, development information, service information and sales information are stored in such a manner as to be utilized with reference to serial numbers as their keys. Therefore, since products can be readily classified according to buyer and products supplied to the same buyer can be distinguished from one another, a history of each product can be readily learned. Further, proper processing can be conducted on a product by referring to such a history of a product.

According to the present invention, since a structural tree is prepared by using part numbers that are respectively given to parts of the same design of an assembled product and is stored in a tree file of a computer, the composition of the product can be recognized readily and clearly by referring to the structural tree. Further, since a unique serial number is assigned to each of at least major parts of an product, and such serial numbers are linked to the part numbers and the linked numbers are all stored in the computer file, serial numbers and part numbers are properly associated with each other. Still further, since a major part is marked with a serial number, information about the part can be retrieved using its serial number.

It should also understood that the foregoing relates to only preferred embodiments of the invention, and that it is intended to cover all changes and modifications of the examples of the invention herein chosen for the purpose of the disclosure, which do not constitute departures from the spirit and scope of the invention.

What is claimed is:

1. A method of managing of products each having a plurality of parts, comprising the steps of:
creating an original structural tree of a product which defines a relationship between the product and its parts:
assigning part numbers to the product and parts, the same part number being assigned to products and parts having the same structure;
assigning unique serial numbers to the product and at least major parts thereof, different serial numbers being assigned to separate products and parts even if they have the same structure;
entering the part numbers and serial numbers in the structural tree;
storing the resultant structural tree in a database connected to a computer;
marking the serial numbers on the product and parts assigned therewith.

2. The method as defined in claim 1, further comprising the steps of:
linking attributes of the product and parts to which the serial numbers are assigned, to the serial numbers; and
storing the attributes together with their linking information in the database.

3. The method as defined in claim 1, further comprising the steps of:
linking histories of the product and parts to which the serial numbers are assigned, to the serial numbers: and
storing the histories together with their linking information in the database.

4. A parts management server connected to a database and user terminals, for managing products each having a plurality of parts, comprising:
means for supporting a user to create a structural tree of a product to be stored in the database, which defines a relationship between the product and its parts, and contains part numbers assigned to the product and the parts and unique serial numbers assigned to the product and at least major parts, the same part number being assigned to products and parts having the same structure, but different serial numbers being assigned to products and parts even if they have the same structure; and
means for providing information of the structural tree stored in the database to a user terminal when it is retrieved by using the serial numbers.

5. The server as defined in claim 4, wherein the supporting means is further adapted to support the user to enter in the database, attributes of the product and parts to which the serial numbers are assigned.

6. The server as defined in claim 5, the supporting means is further adapted to support the user to enter in the database, histories of the product and parts to which the serial numbers are assigned.

7. A structural tree of a product each having a plurality of parts, for managing the product, wherein the structural tree is made by the steps of:
creating an original structural tree of a product which defines a relationship between the product and its parts;
assigning part numbers to the product and parts, the same part number being assigned to products and parts having the same structure;
assigning unique serial numbers to the product and at least major parts thereof, different serial numbers being assigned to separate products and parts even if they have the same structure;
entering the part numbers and serial numbers in the structural tree; and
storing the resultant structural tree in a database connected to a computer.
